(19) United States
(12) Patent Application Publication
(10) Pub. No.: US 2015/0125728 A1
(43) Pub. Date: May 7, 2015

(54) PACKING TRAY

(71) Applicant: Samsung SDI Co., Ltd., Yongin-si (KR)

(72) Inventors: Jae-Ok YI, Yongin-si (KR); Jin-Young MOON, Yongin-si (KR)

(21) Appl. No.: 14/490,540

(22) Filed: Sep. 18, 2014

(30) Foreign Application Priority Data
Nov. 7, 2013 (KR) 10-2013-0134591

(51) Int. Cl. H01M 2/10

(52) U.S. Cl. CPC H01M 2/1022
USPC 429/99; 206/703

(57) ABSTRACT

A packing tray for battery cells is disclosed. In one aspect, the packing tray includes a plurality of accommodating slots respectively configured to accommodate a plurality of battery cells, wherein each of the battery cells includes first and second ends opposing each other and a middle portion interposed between the first and second ends. Each of the accommodating slots includes a first support portion configured to support the first end of the battery cell, a second support portion configured to support the middle portion of the battery cell, and a well configured to receive the second end of the battery cell. Accordingly, it is possible to load a large number of battery cells in the packing tray and to easily unload the battery cells.

### CROSS-REFERENCE TO RELATED APPLICATIONS

This U.S. non-provisional patent application claims priority under 35 U.S.C. §119 of Korean Patent Application No. 10-2013-0134591, filed on Nov. 7, 2013, the contents of which are hereby incorporated by reference in its entirety.

### BACKGROUND

1. Field

The described technology generally relates to a packing tray, and more particularly, to a packing tray for battery cells.

2. Description of the Related Technology

Today, rechargeable batteries fill a particular need in a range of products including portable consumer electronics. Generally, after manufacturing and assembling components such as battery cells, the components are arranged in a packing tray for storage or shipping. Battery cells come in a variety of shapes according to the supported product category. Some standard shapes include cylinders and flat or planar products. New products are requiring non-standard shapes and one such product is a smartwatch where a curved battery may be used with a curvature fit over a wearer's wrist. This has presented the opportunity for new packaging trays that can accommodate batteries having the new shapes.

### SUMMARY OF CERTAIN INVENTIVE ASPECTS

One inventive aspect is a packing tray having an improved compression strength in a substantially vertical direction between adjacent packing trays stacked without a separate buffering member. The packing tray can accommodate a large number of battery cells and easily unload the battery cells.

Another aspect is a packing tray for battery cells having an improved compression strength in a vertical direction between adjacent packing trays stacked without any separate buffering member. The packing tray can accommodate a large number of battery cells and easily unload the battery cells.

Another aspect is a packing tray, including a plurality of accommodating slots respectively configured to accommodate a plurality of battery cells, wherein each of the battery cells includes first and second ends opposing each other and a middle portion interposed between the first and second ends, wherein each of the accommodating slots includes a first support portion configured to support the first end of the battery cell, a second support portion configured to support a middle portion of the battery cell, and a well provided configured to receive the second end of the battery cell.

The well is further configured such that the battery cell at least partially moves about the second support portion when a downward force is applied to the second end of the battery cell.

The well may further include a bottom which extends along a first plane and wherein the first support portion protrudes upwardly from the first plane.

The second support portion may protrude upwardly from the first plane.

The accommodating slot may further include a connecting portion formed lower than upper surfaces of each of the first and second support portions and the connecting portion may connect the first and second support portions.

The first support portion, the second support portion, the well and the connecting portion may be integrally formed.

The battery cell may be a curved cell. The first and second support portions may have curved upper surfaces corresponding to the curvature of the curved cell.

The upper surfaces of the first and second support portions may be inclined with respect to the first plane.

The distance between the first plane and the inclined surface of the first support portion increases from the first end of the battery cell to the middle portion of the battery cell and the distance between the first plane and the inclined surface of the second support portion decreases from the middle portion of the battery cell to the second end of the battery cell.

The battery cell includes two electrode tabs formed at the first end thereof. The first support portion can include a stopping portion protruding upwardly. The stopping portion secures the battery cell.

The accommodating slots are generally arranged in a matrix arrangement including a plurality of rows and a plurality of columns.

In some embodiments, at least some of the plurality of wells respectively included in the accommodating slots are connected to each other.

The packing tray may further include a pair of first walls and a pair of second walls surrounding the accommodating slots. The pair of first walls may extend in a first direction and protrude upwardly from the first plane. The pair of second walls may extend in a second direction crossing the first direction and protrude upwardly from the first plane.

The packing tray may include a stacking portion protruding upwardly at least a portion of the first and second walls. The packing tray may be stacked on a stacking portion of another packing tray.

The packing tray may include a latching portion formed in at least a portion of the first walls and second walls. The packing tray may be stacked on a stacking portion of another packing tray.

The packing tray may include a plurality of stacking portions. The stacking portions may be formed between two opposing ends of each of the first and second walls.

The packing tray may further include at least one first partitioning portion separating the accommodating slots from each other. The first partitioning portion may be connected to the second walls, extend in the first direction, and protrude upwardly from the first plane.

The packing tray may further include at least one second partitioning portion separating the accommodating slots from each other. The second partitioning portion may be connected to the first walls, extend in the second direction, and protrude upwardly from the first plane.

A stacking portion protruding upwardly from an upper surface of at least one of the first and second partitioning portions. The packing tray may be stacked with another packing tray through the stacking portion.

A latching portion may be formed at a position corresponding to that of the stacking portion and recessed in an outer surface of the first and second partitioning portions. The packing tray may be stacked with another packing tray with the latching portion placed on the stacking portion.

The second partitioning portion may further include a plurality of sub-partitioning portions extending in the first direction and the sub-partitioning portions may protrude upwardly from the first plane.

The accommodating slots may be arranged into a minor symmetric structure in which the left and right portions of the accommodating slots are symmetric to each other about the second direction.

Another aspect is a packing tray for battery cells including a plurality of accommodating slots, each slot configured to accommodate a battery cell and a plurality of walls surrounding the accommodating slots, wherein each of the accommodating slots includes first and second support portions configured to support different portions of the battery cell, and wherein each of the accommodating slots is configured to support the battery cell such that when one end of the battery cell is pressed down, the battery cell at least partially moves about the second support portion.

The packing tray may further include a stacking portion protruding upwardly from each of the walls, wherein the stacking portions of the packing tray are configured to be placed on stacking portions of another packing tray, and a latching portion formed in each of the walls, wherein the latching portion of the packing tray is configured to be stacked on a stacking portion of the other packing tray, wherein the latching portion is recessed in an outer surface of the wall.

According to at least one embodiment, it is possible to reinforce the compression strength of the packing tray in a vertical direction without including any separate buffering member.

Further, it is possible to accommodate a large number of battery cells and easily unload the battery cells.

### BRIEF DESCRIPTION OF THE DRAWINGS

FIG. 1 is a front view illustrating standard packing trays stacked together.

FIG. 2 is a perspective view of a packing tray according to an embodiment.

FIG. 3 is an enlarged view showing portion A of FIG. 2.

FIG. 4 is a sectional view taken along line A-A of FIG. 2.

FIG. 5 is an enlarged view showing portion A of FIG. 4.

FIG. 6 is a sectional view showing a state in which the packing tray is stacked with another packing tray according to an embodiment.

FIG. 7 is an enlarged view showing portion A of FIG. 6.

FIG. 8 is a perspective view illustrating a method of removing a battery cell from the packing tray.

### DETAILED DESCRIPTION OF CERTAIN INVENTIVE EMBODIMENTS

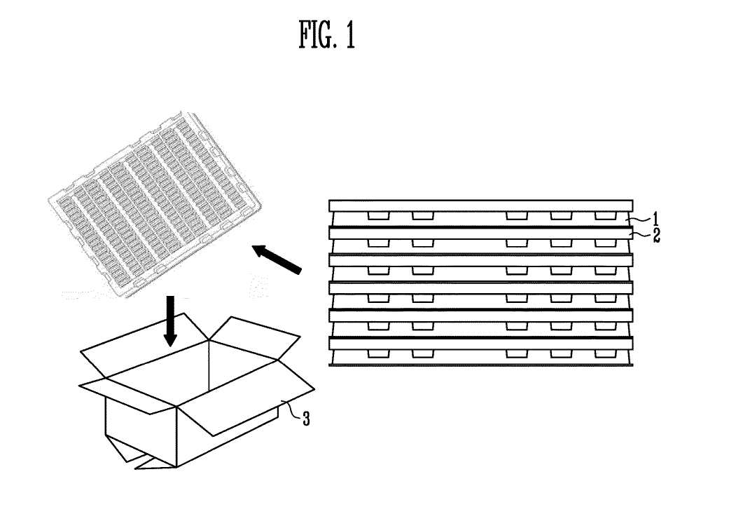

FIG. 1 is a front view showing standard packing trays stacked together. As shown in FIG. 1, the standard packing tray 1 includes an area in which manufactured components can be placed and a corrugated cardboard pad 2 used as a buffering member between adjacent packing trays 1.

In this stacked structure, a corrugated cardboard pad 2 is required between each pair of adjacent packing trays 1, which increases the cost of the entire structure. Further, the standard structure does not include support in the center of the packing tray. Thus, a vertical compression load acting in the center of the packing tray 1 can deform the packing tray 1 when an outside force is applied to the middle of the packing tray, and therefore, the components may be seriously damaged.

The packing tray should have a structure enabling the accommodation of a large number of components and the components should be easily unloadable from the packing tray. However, due to the structure of the standard packing tray described above, the standard packing tray cannot achieve the abovementioned functions.

In the following detailed description, only certain exemplary embodiments of the described technology have been shown and described, simply by way of illustration. As those skilled in the art would realize, the described embodiments may be modified in various different ways, all without departing from the spirit or scope of the described technology. Accordingly, the drawings and description are to be regarded as illustrative in nature and not restrictive. In addition, when an element is referred to as being “on” another element, it can be directly on the other element or be indirectly on the another element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements.

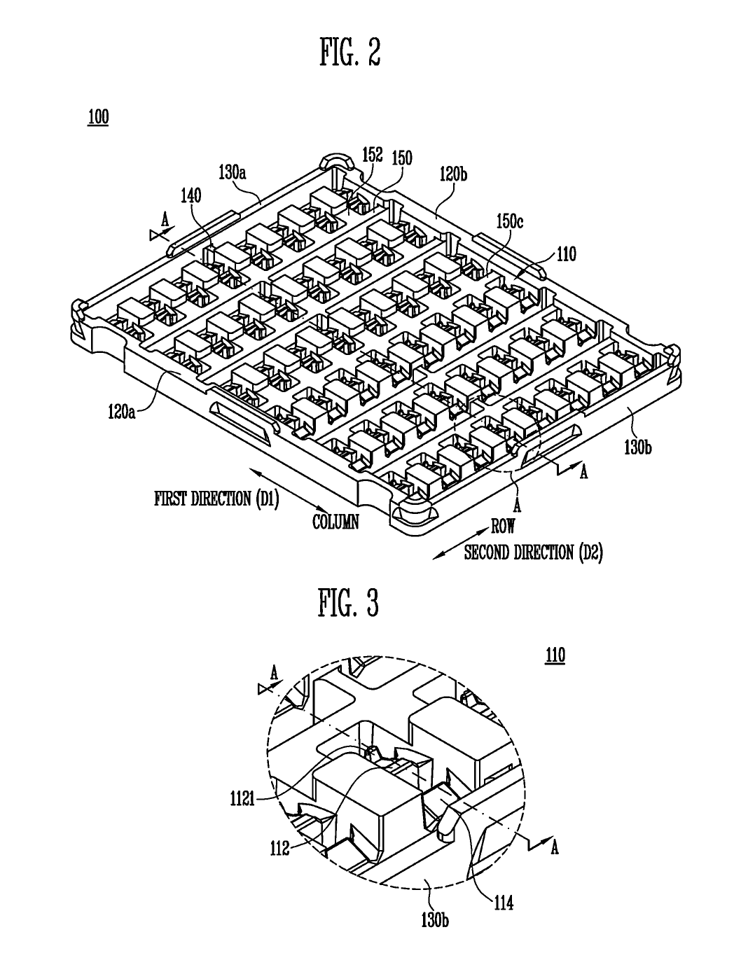

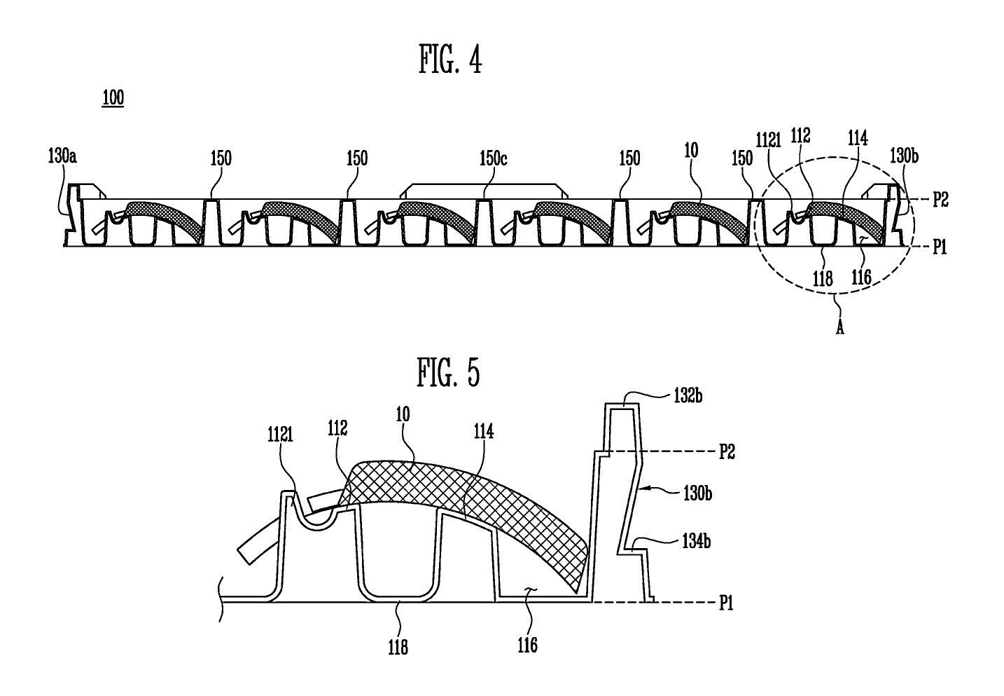

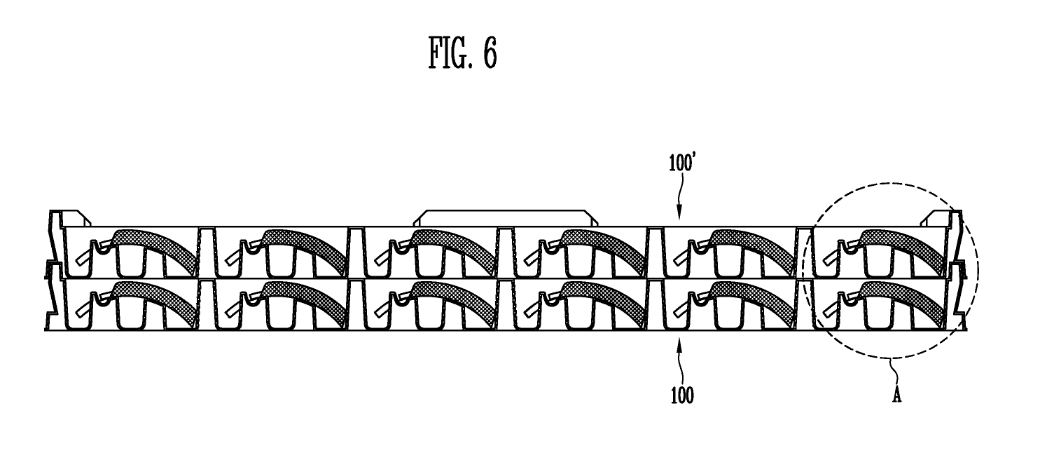

Referring to FIGS. 2 to 5, the packing tray 100 includes a plurality of accommodating slots 110 respectively configured to accommodate a plurality of battery cells 10, a pair of first walls 120a and 120b and a pair of second walls 130a and 130b surrounding the accommodating slots 110, and first and second partitioning portions 140 and 150 separating the accommodating slots 110 from each other.

Throughout the specification, the battery cell 10 is described and illustrated as a curved battery cell (hereinafter, referred to as ‘cell’), and the packing tray 100 is described as a tray for packing the curved cell. However, the described technology is not limited thereto, and the packing tray 100 may be modified to accommodate a planar cell or another product, e.g., a display module.

As shown in FIGS. 2 to 5, the plurality of accommodating slots 110, the pair of first walls 120a and 120b, the pair of second walls 130a and 130b, and the first and second partitioning portions 140 and 150 may be integrally formed using one mold member.

For example, the entire structure of the packing tray including the plurality of accommodating slots 110, the pair of first walls 120a and 120b, the pair of second walls 130a and 130b, and the first and second partitioning portions 140 and 150 can be formed by press-molding a synthetic resin sheet. Alternatively, the entire structure of the packing tray can be formed by injection-molding a synthetic resin material. However, the described technology is not limited to the above examples, and various molding methods can be employed in forming the structure of the packing tray.

First, the accommodating slots 110 according to the present embodiment are arranged in a matrix arrangement including a plurality of rows and a plurality of columns. Each of the accommodating slots 110 includes a first support portion 112, a second support portion 114, a well 116 and a connecting portion 118.

More specifically, the first support portion 112 supports an upper end of the cell 10 and the second support portion 114 supports a middle portion of the cell 10. The well 116 has sufficient space such that a lower end of the cell 10 can be applied with an external downward force and move about the second support portion 114 which functions as a fulcrum.

Due to the configuration of the first and second support portions 112 and 114 and the well 116, the cell mounted in the accommodating slot 110 can be easily unloaded without the addition of any separate space for unloading the cell.

That is, one accommodating slot 110 is entirely formed as a space capable of accommodating one cell. In this case, the upper end of the cell 10 is mounted on the first support portion 112 of the accommodating slot 110, the middle portion of the cell 10 is mounted on the second support portion 114 of the accommodating slot 110, and the lower end of the cell 10 is accommodated in the space defined by the well 116. When an external downward force is applied to the lower end of the cell, the lower end of the cell is move downward with respect to the second support portion 114 acting as a fulcrum, so that a user can easily unload the cell from the accommodating slot 110.

The connecting portion 118 according to this embodiment connects the first and second support portions 112 and 114 to each other.

In this case, the first and second support portions 112 and 114 may respectively support the upper end and the middle portion of the cell. The first and second support portions 112 and 114 protrude upwardly from a plane P1 (hereinafter, referred to as a ‘first plane’ for convenience of explanation) on which the bottom of the well 116 is formed. The connecting portion 118 connects the first and second support portions 112 and 114 and does not protrude from the plane P1. Thus, the first and second support portions 112 and 114 are spaced apart from each other at a predetermined distance.

That is, the connecting portion 118 is formed lower than the first and second support portions 112 and 114 and does not directly support the cell 10. This has an advantage in that an unnecessary contact area between the support portions 112 and 114 and the cell 10 is reduced.

As shown in the embodiments of FIGS. 2 to 5, at least some of the wells 112 respectively included in the accommodating slots 110 are connected to each other.

The well 116 is provided together with the second support portion 114 such that the unloading the cell 10 can be easily performed, and thus, the wells 116 are not necessarily distinguished from each other but may be connected to each other. This has an advantage in that it is possible to save in production costs by simplifying the mold used to form the packing tray.

Continuously, referring to FIGS. 2 to 5, each of the first and second support portions 112 and 114 according to this embodiment has an upper surface with a curvature corresponding to the curvature of the cell 10 so that the cell 10 accommodated in the accommodating slot 110 can be stably mounted on the support portions 112 and 114.

As an example, in the case where the cell 10 accommodated in the accommodating slot 110 is a curved cell, the upper surfaces of the first and second support portions 112 and 114 may have a curved surface corresponding to the curvature of the curved cell. That is, the first support portion 112 supporting the upper end of the curved cell may have an inclined surface with a height which increases towards the middle portion of the cell from the upper end of the cell. The second support portion 114 supporting the middle portion of the curved cell may have an inclined surface with a height which decreases towards the lower end of the cell from the middle portion of the cell.

As another example, where the cell 10 accommodated in the accommodating slot 110 is a planar cell, the upper surfaces of the first and second support portions 112 and 114 may also be planar surfaces which can be adhered closely to the planar cell. In this case, the first and second support portions 112 and 114 preferably have the same height, so as to respectively support an upper and a middle portion of the planar cell.

Accordingly, the cell can be stably mounted on the support portions 112 and 114.

According to some embodiments, the first support portion 112 includes a stopping portion 1121 formed protruding upwardly from the first support portion so that the cell 10 accommodated in the accommodating slot 110 can be stably mounted on the first and second support portions 112 and 114.

That is, the stopping portion 1121 protrudes upwardly between electrode tabs included in the upper end of the cell to fix the movement of the cell.

The cell is adhered closely to the support portions 112 and 114 having the upper surfaces corresponding to the curvature of the cell and the upper end of the cell is fixed by the stopping portion 1121 formed protruding upwardly from the first support portion 112 so that the cell is stably mounted in the accommodating slot 110.

As such, each of the accommodating slots 110 is formed to have a size corresponding to that of the cell 10, thereby accommodating the cell 10.

As described above, the accommodating slots 110 are arranged in a matrix arrangement including the pair of first walls 120a and 120b, the pair of second walls 130a and 130b, and the first and second partitioning walls 140 and 150. Together, the walls form the frame structure of the accommodating slots on the outside and the inside of the packing tray and these walls will be described in detail below.

As shown in the embodiments of FIGS. 2 to 5, the pair of first walls 120a and 120b surrounding the accommodating slots 110 extend in the length direction (hereinafter, referred to as a ‘first direction’ for convenience of illustration) of the cells accommodated in the accommodating slots 110. The pair of first walls 120a and 120b also protrude from the first plane P1 on which the bottom of the well 116 is formed.

Here, the height of a plane P2 (hereinafter, referred to as a ‘second plane’ for convenience of illustration) coinciding with the upper surface of the wall is preferably located higher than that of each of the support portions 112 and 114 so that the cells accommodated in the accommodating slots 110 can be safely placed in the accommodating slots 110.

The one or more first partitioning portions 140 extend in the first direction and protrude upwardly from the first plane P1 on which the bottom of the well 116 is formed.

Since the first partitioning portion 140 extends in the first direction, the first partitioning portion 140 may be connected to the pair of second walls 130a and 130b.

According to some embodiments, the first partitioning portion 140 separates a plurality of the accommodating slots 110 from each other and divides the accommodating slots down the middle. In these cases, the first partitioning portion 140 is connected to a middle portion of the pair of second walls 130a and 130b.

The one or more second partitioning portions 150 separating the accommodating slots 110 from each other also extend in a second direction perpendicular to the first direction. The second partitioning portion 150 protrudes upwardly from the first plane P1 on which the bottom of the well 116 is formed.

Since the second partitioning portion 150 extends in the second direction, the second partitioning portion 150 may be connected to the pair of first walls 120a and 120b.

According to some embodiments, the second partitioning portions 150 extend in the second direction and protrude upwardly from the first plane P1. The accommodating slots 110 arranged in the first direction can be defined as a column and the accommodating slots 110 arranged in the second direction can be defined as a row. In such configurations, the second partitioning portions 150 are formed between every row, thereby separating the accommodating slots in each row from each other.

According to some embodiments, the second partitioning portion 150 includes a plurality of sub-partitioning portions 152 extending in the first direction and protruding upwardly from the first plane P1.

The sub-partitioning portions 152 branch off from the second partitioning portion 150 in the first direction and separate the columns of accommodating slots 110 from each other.

In the configuration where the second partitioning portions 150 are provided with the sub-partitioning portions 152 which are formed every row to separate the accommodating slots 110, it is possible to meet various packing standards by cutting along the second partitioning portions 150. For example, where only eight cells are allowed per packing tray according to packing rules associated with aviation transporters, each the second partitioning portions 150 can be cut in order to meet the aerial packing rules.

The height of a plane P3 (hereinafter, referred to as a ‘third plane’ for convenience of illustration), coinciding with the upper surfaces of the partitioning portions 140 and 150 is preferably higher than the upper surfaces of each of the support portions 112 and 114 and is preferably lower than the second plane P2 which coincides with the upper surfaces of the walls 120a, 120b, 130a and 130b.

Moreover, the accommodating slots 110 according to some embodiments are arranged to be symmetrically mirrored about a center second partitioning portion 150c. In these cases, the accommodating slots 110 are symmetric about the center second partitioning portion 150c formed at a middle portion of the accommodating slots 110 in the second direction.

For example, when the curved cells 10 are respectively loaded in the accommodating slots 110 arranged in the matrix arrangement, the curved cells 10 may be loaded so that the electrode tabs positioned at the upper end of the curved cells face the second partitioning portion 150c.

This has an advantage in that an impact force applied to the packing tray 100 from the exterior is transferred to the opposite end of the curved cell 10 from the electrode tab thereby protecting the cell from external impact.

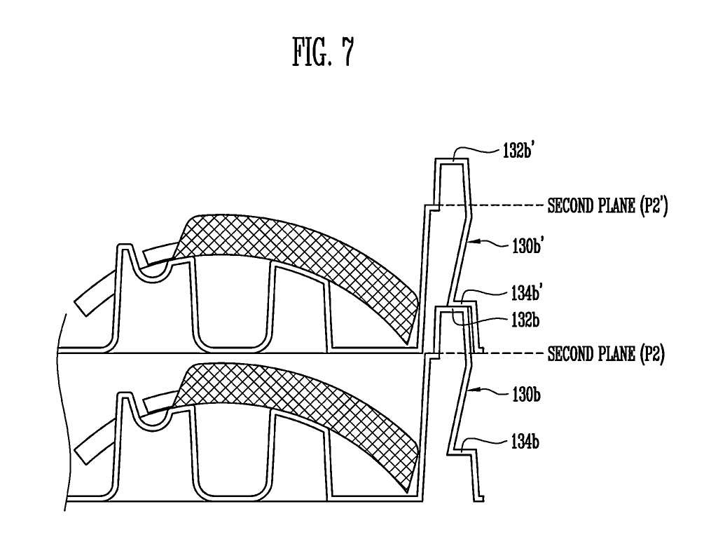

The packing tray 100 according to the described technology has a structure which allows for stacking with another packing tray 100′. This structure will be described in detail with reference to FIGS. 6 and 7.

FIG. 6 is a sectional view illustrating the packing tray 100 being stacked with another packing tray 100′ according to an embodiment.

FIG. 7 is an enlarged view showing portion A of FIG. 6.

As shown in FIGS. 6 and 7, a stacking portion 132b is formed in the second wall 130b protruding upwardly from the second plane P2 coinciding with the upper surface of the second wall 130b. In this case, it is assumed that, for convenience of illustration, the stacking portion 132b is formed at a middle portion of the second wall 130b.

In addition, a stacking portion 132a is formed in the second wall 130a protruding upwardly from the second plane P2. The stacking portion 132a formed at the second wall 130a is preferably formed at a middle portion of the second wall 130a so that the structure of the packing tray is laterally symmetric.

Although not shown in FIGS. 6 and 7, similarly, stacking portions 122a and 122b are respectively formed in the first walls 120a and 120b protruding upwardly from the second plane P2 coinciding with the upper surfaces of the first walls 120a and 120b. The stacking portions 122a and 122b are preferably formed at middle portions of the respective first walls 120a and 120b to maintain a symmetric structure.

Referring to FIGS. 6 and 7, a latching portion 134b is formed at a position corresponding to that of the stacking portion 132b and the latching portion 134b is recessed in the outer surface of the second wall 130b.

In certain embodiments, a latching portion 134a is formed at a position corresponding to that of the stacking portion 132a and the latching portion 134a is recessed in the outer surface of the second wall 130a. The latching portion 134a is formed opposing the latching portion 134b formed in the second wall 130b. Similarly, latching portions 124a and 124b are formed at positions corresponding to those of the stacking portions 122a and 122b and the latching portions 124a and 124b are respectively recessed in the outer surfaces of the first walls 120a and 120b.

Accordingly, the packing tray 100 according to certain embodiments can be stacked with another packing tray 100′ through the stacking portions 122a, 122b, 132a and 132b and the latching portions 124a, 124b, 134a and 134b.

That is, as shown in FIGS. 6 and 7, a latching portion 134b′ of the packing tray 100′ can be positioned on the packing tray 100 and placed on the stacking portion 132b of the packing tray 100. Thereby, the packing trays can be stacked together.

Additionally, the structure of the stacking and latching portions for stacking the packing trays may also be provided on the partitioning portions 140 and 150 in addition to the walls 120 and 130.

For example, similar to the walls 120a, 120b, 130a and 130b described above, a stacking portion (not shown) may be provided on the upper surfaces of the partitioning portions 140 and 150 and may protrude upwardly from the third plane. The stacking portions (not shown) may be formed at one or more positions of the first and second partitioning portions 140 and 150. Similarly, a latching portion (not shown) may be formed at a position corresponding to that of the stacking portion (not shown) and may be recessed in the outer surfaces of the first and second partitioning portions 140 and 150.

The packing trays can also have a stacked structure therebetween through the stacking portion (not shown) and the latching portion (not shown), which are formed at the first and second partitioning portions 140 and 150.

Since the other components of the present embodiment are the same as those of the previous embodiments except for the stacking portion (not shown) and the latching portion (not shown) included in the partitioning portions 140 and 150, detailed descriptions thereof will be omitted.

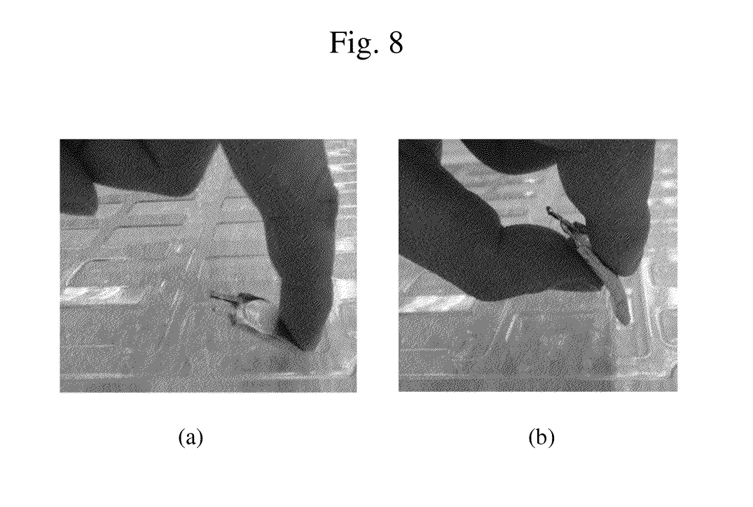

FIG. 8 is a perspective view illustrating a method of removing a battery cell from the packing tray. As shown in FIG. 8, the battery cell 10 is accommodated in the accommodating slot 110. As shown in FIG. 8(a), a downward force can be applied to the lower end of the battery cell 10 in order to lift the upper end of the battery cell 10 from the accommodating slot. After the upper end of the battery cell 10 has been lifted, the bottom of the battery cell 10 can be reached as illustrated in FIG. 8(b). By moving the battery cell 10 about the second support portion 114, the battery cell 10 can be easily removed without touching the electrode tabs of the battery cell 10.

Exemplary embodiments have been disclosed herein, and although specific terms have been employed, they are used and are to be interpreted in a generic and descriptive sense only and not for the purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A packing tray for battery cells, comprising:
a plurality of accommodating slots respectively configured to accommodate a plurality of battery cells, wherein each of the battery cells includes first and second ends opposing each other and a middle portion interposed between the first and second ends,
wherein each of the accommodating slots comprises:
a first support portion configured to support the first end of the battery cell;
a second support portion configured to support the middle portion of the battery cell; and
a well configured to receive the second end of the battery cell.

2. The packing tray of claim 1, wherein the well is further configured such that the battery cell at least partially moves about the second support portion when a downward force is applied to the second end of the battery cell.

3. The packing tray of claim 2, wherein the well further includes a bottom which extends along a first plane and wherein the first support portion protrudes upwardly from the first plane.

4. The packing tray of claim 3, wherein the second support portion protrudes upwardly from the first plane.

5. The packing tray of claim 4, wherein the accommodating slot further comprises a connecting portion formed lower than upper surfaces of each of the first and second support portions and wherein the connecting portion connects the first and second support portions.

6. The packing tray of claim 5, wherein the first support portion, the second support portion, the well and the connecting portion are integrally formed.

7. The packing tray of claim 5, wherein the battery cell is a curved cell and wherein the first and second support portions have curved upper surfaces corresponding to the curvature of the curved cell.

8. The packing tray of claim 5, wherein the upper surfaces of the first and second support portions are inclined with respect to the first plane.

9. The packing tray of claim 7, wherein a distance between the first plane and the inclined surface of the first support portion increases from the first end of the battery cell to the middle portion of the battery cell and wherein a distance between the first plane and the inclined surface of the second support portion decreases from the middle portion of the battery cell to the second end of the battery cell.

10. The packing tray of claim 1, wherein the battery cell comprises two electrode tabs formed at the first end thereof, wherein the first support portion includes a stopping portion i) protruding upwardly from the first support portion and ii) configured to secure the battery cell therein.

11. The packing tray of claim 1, wherein the accommodating slots are arranged in a matrix arrangement including a plurality of rows and a plurality of columns.

12. The packing tray of claim 11, wherein at least some of the wells respectively included in the accommodating slots are connected to each other.

13. The packing tray of claim 11, further comprising a pair of first walls and a pair of second walls surrounding the accommodating slots, wherein the well further includes a bottom which extends along a first plane, wherein the first walls extend in a first direction and protrude upwardly from the first plane, and wherein the second walls extend in a second direction crossing the first direction and protrude upwardly from the first plane.

14. The packing tray of claim 13, further comprising a stacking portion protruding upwardly from at least a portion of the first and second walls, wherein the packing tray is configured to be stacked on another packing tray.

15. The packing tray of claim 14, further comprising a latching portion formed in at least a portion of the first and second walls and wherein the latching portion of the packing tray is configured to be stacked on a stacking portion of the other packing tray.

16. The packing tray of claim 14, further comprising a plurality of stacking portions, wherein the stacking portions are formed between two opposing ends of each of the first and second walls.

17. The packing tray of claim 13, further comprising at least one first partitioning portion separating the accommodating slots from each other, wherein the first partitioning portion: i) is connected to the second walls, ii) extends in the first direction, and iii) protrudes upwardly from the first plane, and at least one second partitioning portion separating the accommodating slots from each other, wherein the second partitioning portion: i) is connected to the first walls, ii) extends in the second direction, and iii) protrudes upwardly from the first plane.

18. The packing tray of claim 13, wherein the accommodating slots are symmetrically mirrored about a mirror axis extending in the second direction.

19. A packing tray for battery cells, comprising:
a plurality of accommodating slots, each slot configured to accommodate a battery cell; and
a plurality of walls surrounding the accommodating slots;
wherein each of the accommodating slots comprises first and second support portions configured to support different portions of the battery cell, and
wherein each of the accommodating slots is configured to support the battery cell such that when one end of the battery cell is pressed down, the battery cell at least partially moves about the second support portion.

20. The packing tray of claim 19, further comprising:
a stacking portion protruding upwardly from each of the walls, wherein the stacking portions of the packing tray are configured to be placed on stacking portions of another packing tray; and
a latching portion formed in each of the walls, wherein the latching portion of the packing tray is configured to be stacked on a stacking portion of the other packing tray, wherein the latching portion is recessed in an outer surface of the wall.
